(19) United States
(12) Patent Application Publication
(10) Pub. No.: US 2023/0288778 A1
(43) Pub. Date: Sep. 14, 2023

(54) CAMERA MODULE AND MOBILE TERMINAL

(71) Applicant: Sharp Sensing Technology Corporation, Tenri City (JP)

(72) Inventor: Akihiro IIDA, Tenri City (JP)

(21) Appl. No.: 18/111,710

(22) Filed: Feb. 20, 2023

(30) Foreign Application Priority Data
Mar. 11, 2022 (JP) 2022-037779

(51) Int. Cl. G03B 9/10; G02B 7/36; H04N 23/67; H04N 23/50

(52) U.S. Cl. CPC G03B 9/10; G02B 7/365; H04N 23/672; H04N 23/50

(57) ABSTRACT

A camera module includes the following: an image sensor configured to perform photoelectric conversion on incident light; a lens system configured to concentrate the incident light that travels toward the image sensor; an aperture diaphragm having an opening that allows the incident light that travels toward the lens system to pass; and a shield device capable of shielding at least a part of the opening, wherein the shield device changes into at least each of a first shield state where only a first light beam bundle asymmetric with respect to a main light beam of an entire light beam bundle that passes through the entire opening is allowed to pass, and a second shield state where only a second light beam bundle different from the first light beam bundle and asymmetric with respect to the main light beam is allowed to pass.

### CROSS-REFERENCE TO RELATED APPLICATION

The present application claims priority from Japanese Application JP 2022-37779, the content of which is hereby incorporated by reference into this application.

### BACKGROUND OF THE INVENTION

### 1. Field of the Invention

The present disclosure relates to a camera module and a mobile terminal.

### 2. Description of the Related Art

Camera modules that are mounted on mobile terminals, such as smartphones, have been developed in recent years. In such camera modules, image-plane phase-difference autofocus is known as a technique of executing high-speed autofocus, as disclosed in Japanese Unexamined Patent Application Publication No. 2008-134389.

In this image-plane phase-difference autofocus, a plurality of divided images are obtained through pixels where a single micro lens formed on an image sensor includes a plurality of photoelectric conversion units. Accordingly, the phase difference between the plurality of divided images that was obtained is determined. The control unit of the camera module thereafter moves at least one lens constituting a lens system in accordance with the phase difference in such a manner that focus is achieved.

### SUMMARY OF THE INVENTION

The foregoing technique disclosed in Japanese Unexamined Patent Application Publication No. 2008-134389 enables the image-plane phase difference autofocus to achieve focus rapidly. However, obtaining a plurality of divided images requires a pixel for phase detection, that is, a pixel that has a phase difference sensor, to be formed in the image sensor. Thus, the foregoing technique disclosed in Japanese Unexamined Patent Application Publication No. 2008-134389, when used, limits the types of image sensors that are applicable to the camera module. This possibly increases costs for the camera module.

Further, the foregoing technique disclosed in Japanese Unexamined Patent Application Publication No. 2008-134389 requires increase in the number of pixels that have a phase difference sensor, in order to enhance autofocus accuracy. However, image correction is required when a pixel that has a phase difference sensor is used not only as a pixel for phase difference detection, but also as a pixel for image capturing in order to maintain the total number of imaging pixels. Making a correction in this case increases the load on data processing, whereas image quality deteriorates if no correction is made.

To solve the above problems, the present disclosure aims to provide a camera module and a mobile terminal that can achieve an image-plane phase-difference autofocus function without depending on an image sensor that has a phase difference sensor.

A camera module of the present disclosure includes the following: an image sensor configured to perform photoelectric conversion on incident light; a lens system configured to concentrate the incident light that travels toward the image sensor; an aperture diaphragm having an opening that allows the incident light that travels toward the lens system to pass; and a shield device capable of shielding at least a part of the opening, wherein the shield device changes into at least each of a first shield state where only a first light beam bundle asymmetric with respect to a main light beam of an entire light beam bundle that passes through the entire opening is allowed to pass, and a second shield state where only a second light beam bundle different from the first light beam bundle and asymmetric with respect to the main light beam is allowed to pass.

A mobile terminal of the present disclosure is a mobile terminal including the foregoing camera module, wherein the shield device includes a transmission/non-transmission switching panel unit, the transmission/non-transmission switching panel unit includes a first region that is brought into a transmission state in the first shield state, and that is brought into a non-transmission state in the second shield state, and a second region that is brought into a non-transmission state in the second shield state, and that is brought into a transmission state in the second shield state, and the transmission/non-transmission switching panel unit is a part of a display panel configured to display an image.

### BRIEF DESCRIPTION OF THE DRAWINGS

FIG. 1 is a front view of a mobile terminal incorporating a camera module according to a first preferred embodiment;

FIG. 2 is a perspective view of the camera module according to the first preferred embodiment;

FIG. 3 is a sectional view of a schematic configuration of the camera module according to the first preferred embodiment;

FIG. 4 is a sectional view of the camera module according to the first preferred embodiment being in focus;

FIG. 5 schematically illustrates the in-focus position and out-of-focus position of the camera module according to the first preferred embodiment;

FIG. 6 illustrates an example image taken by an image sensor with the camera module according to the first preferred embodiment being in focus;

FIG. 7 illustrates an example image taken by the image sensor with the camera module according to the first preferred embodiment being out of focus;

FIG. 8 illustrates the relationship between a first shield state of a shield device of the camera module according to the first preferred embodiment, light incident upon the image sensor, and an image obtained by the image sensor;

FIG. 9 illustrates the relationship between a second shield state of the shield device of the camera module according to the first preferred embodiment, light incident upon the image sensor, and an image obtained by the image sensor;

FIG. 10 illustrates disagreement between the coordinates of an image obtained by the image sensor in the first shield state in the first preferred embodiment and the coordinates of an image obtained by the image sensor in the second shield state;

FIG. 11 illustrates the relationship between phase difference and out-of-focus in image-plane phase-difference autofocus of the camera module according to the first preferred embodiment;

FIG. 12 is flowchart showing an autofocus procedure in the camera module according to the first preferred embodiment;

FIG. 13 is a sectional view of a schematic configuration of a camera module according to a second preferred embodiment;

FIG. 14 illustrates a shield device of the camera module according to the second preferred embodiment covering an opening;

FIG. 15 illustrates the shield device of the camera module according to the second preferred embodiment being in a first shield state;

FIG. 16 illustrates the shield device of the camera module according to the second preferred embodiment being in a second shield state;

FIG. 17 is a sectional view of a shield device of a camera module according to a third preferred embodiment being in a first shield state;

FIG. 18 is a sectional view of the shield device of the camera module according to the third preferred embodiment being in a second shield state; and

FIG. 19 illustrates a mobile terminal incorporating the camera module according to the third preferred embodiment.

### DETAILED DESCRIPTION OF THE INVENTION

Camera modules according to preferred embodiments of the present disclosure and mobile terminals incorporating them will be described with reference to the drawings. It is noted that identical or equivalent components will be denoted by the same signs throughout the drawings, and the description of redundancies will not be repeated.

### First Preferred Embodiment

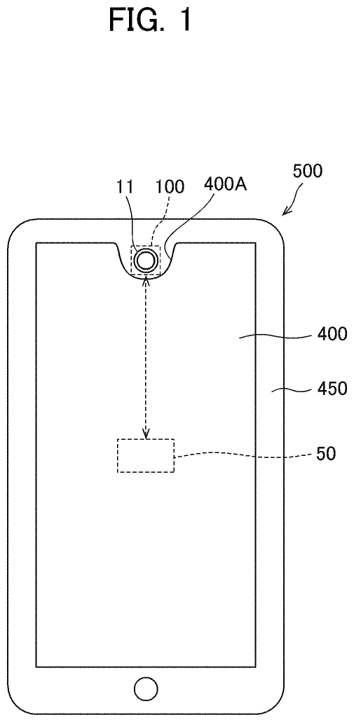

The following describes a camera module 100 according to a first preferred embodiment and a mobile terminal 500 incorporating the same on the basis of FIGS. 1 to 12.

FIG. 1 is a front view of the mobile terminal 500 incorporating the camera module 100 according to this preferred embodiment.

As illustrated in FIG. 1, the mobile terminal 500 according to this preferred embodiment includes a display panel 400, and a bezel 450 surrounding the display panel 400 along the perimeter of the display panel 400. The mobile terminal 500 also incorporates a control unit 50. However, the control unit 50 may be a part of the camera module 100 or may be provided outside the camera module 100.

The camera module 100 is, in the front view (not shown) of the mobile terminal 500, provided in a region on the inside of a notch 400A of the display panel 400 and in a protruding region of the bezel 450. The camera module 100 includes a lens system 10 and a shield device 40.

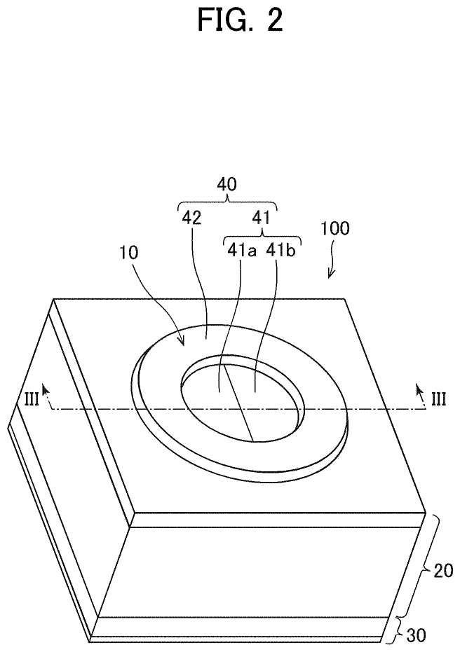

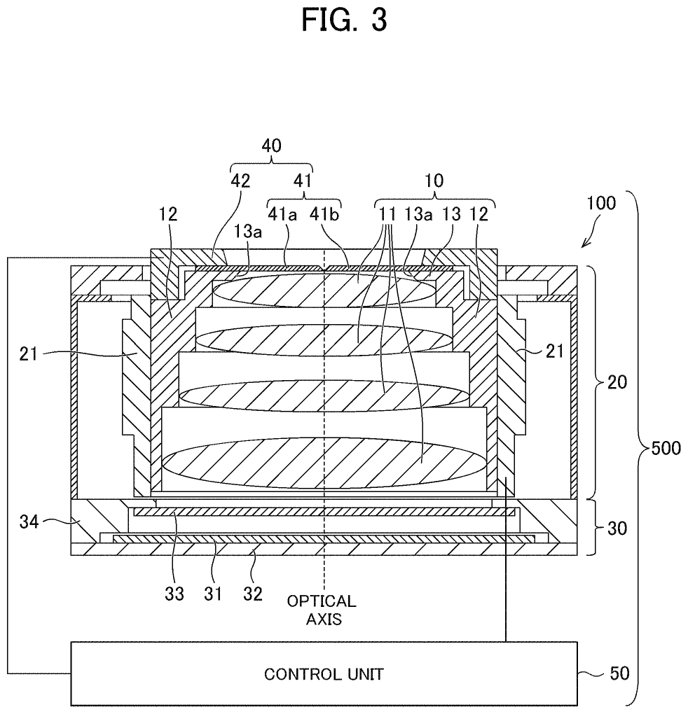

FIG. 2 is a perspective view of the camera module 100 according to this preferred embodiment. FIG. 3 is a sectional view of a schematic configuration of the camera module 100 according to the first preferred embodiment.

As illustrated in FIGS. 2 and 3, the camera module 100 includes the lens system 10, a lens driving device 20, an image pickup unit 30, and the shield device 40.

The lens system 10 includes two or more lenses 11 that concentrate incident light that travels toward an image sensor 31, and a cylindrical lens barrel 12 incorporating the two or more lenses. A part of the lens barrel 12 adjacent to a subject is integral with an aperture diaphragm 13. The aperture diaphragm 13 controls the amount of light that travels toward the image sensor 31 by regulating the area of an opening 13a that allows incident light that travels toward the lens system 10 to pass. It is noted that although not shown, the opening 13a is circular in the front view (not shown) of the camera module 100.

Further, a variable-focus lens for instance, represented by a liquid lens, may be used in the lens system 10 instead of two or more lenses. The variable-focal-length lens, when used, eliminates the need for adjusting the two or more lenses 11 into focus by moving the two or more lenses 11. Hence, there is no need to change the relative positional relationship between the aperture diaphragm 13 and the two or more lenses 11 irrespective of the position of the aperture diaphragm 13. This can improve the accuracy of focus detection.

The lens driving device 20 includes a lens holder 21 surrounding the perimeter of the lens barrel 12 so as to hold the lens barrel 12. The lens driving device 20 moves at least one lens 11 constituting the lens system 10 by moving the lens holder 21 along the optical axis of the lens system 10. That is, the lens driving device 20 has the function of adjusting the lens system 10 into focus. The lens driving device 20 may be any device that has the function of focus adjustment, including a device that includes a stepping motor, a device that includes a piezoelectric element, and a device that includes a voice coil motor (VCM).

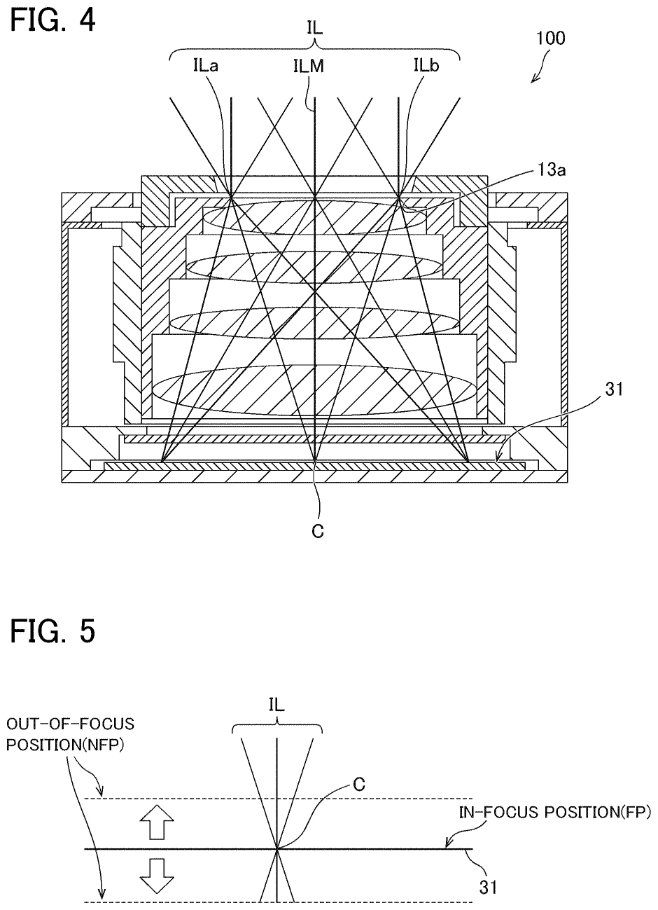

The image pickup unit 30 includes the image sensor 31, a substrate 32, a glass lid 33, and a sensor cover 34. The image sensor 31 performs photoelectric conversion on incident light IL (see FIG. 4). The image sensor 31 is mounted on the front-side surface of the substrate 32. The glass lid 33 is positioned closer to the subject than the image sensor 31. The sensor cover 34 covers the front-side perimeter of the image sensor 31 along the perimeter of the image sensor 31.

The image sensor 31 converts a light beam bundle concentrated by the lens system 10 into an electric signal through photoelectric conversion. The electric signal undergoes software processing and is then converted into an image. The image is output from the camera module 100 to the control unit 50.

The glass lid 33 has the function of blocking infrared light included in the incident light IL (see FIG. 4) that is incident upon the image sensor 31. The glass lid 33 is provided closer to the subject than the image sensor 31. This can reduce the risk of direct attachment of a foreign substance to the image sensor 31. It is noted that if a foreign substance, dust for instance, attaches directly to the image sensor 31, the incident light IL is blocked, thereby degrading an image seriously.

The shield device 40 includes a shield 41 and an opening-and-closing mechanism 42. The shield 41 covers and exposes the opening 13a at the front of the camera module 100. The opening-and-closing mechanism 42 opens and closes the shield 41. The shield 41 in this preferred embodiment includes a first shutter 41a and a second shutter 41b. Each of the first shutter 41a and the second shutter 41b each can perform the opening-and-closing operation independently.

The opening-and-closing mechanism 42 is driven by the control unit 50, thus causing the shield device 40 to open and close each of the first shutter 41a and second shutter 41b independently. This allows a light beam bundle that travels toward the image sensor 31 to transmit, blocks the light beam bundle asymmetrically with respect to a main light beam or does not allow the light beam bundle to transmit.

The shield device 40 includes a plurality of shields 41 composed of the first shutter 41a and the second shutter 41b. The shield device 40 can thus cover only a part of the opening 13a. To be specific, the first shutter 41a is, under the control of the control unit 50, opened in a first shield state and closed in a second shield state. In contrast, the second shutter 41b is, under the control of the control unit 50, opened in the first shield state and closed in the second shield state. The camera module 100 according to this preferred embodiment, which has such a simple structure as the first shutter 41a and second shutter 41b, can achieve the shield device 40 that exerts such a function as earlier described.

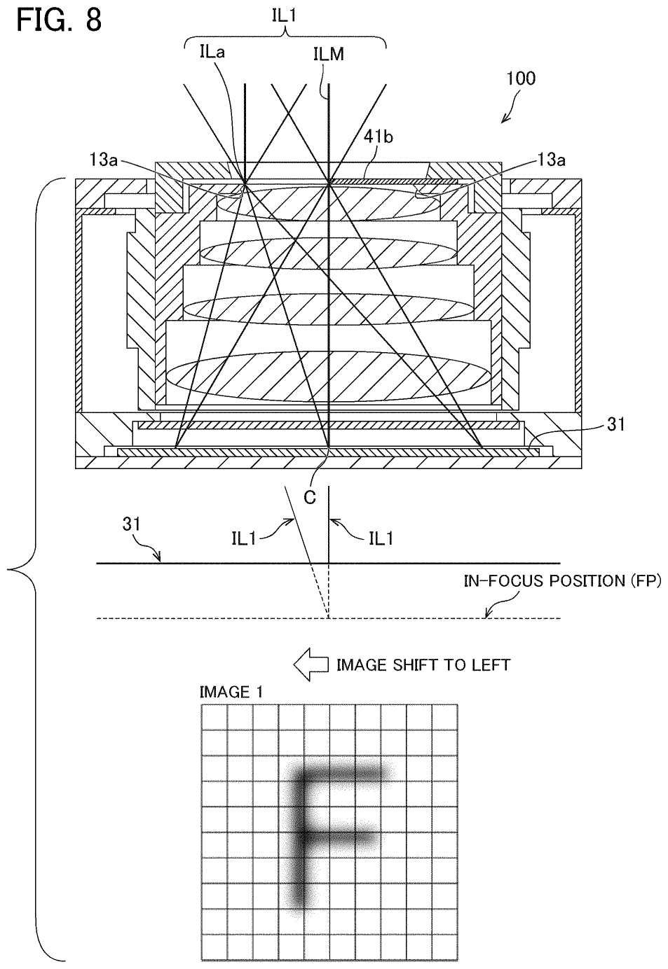

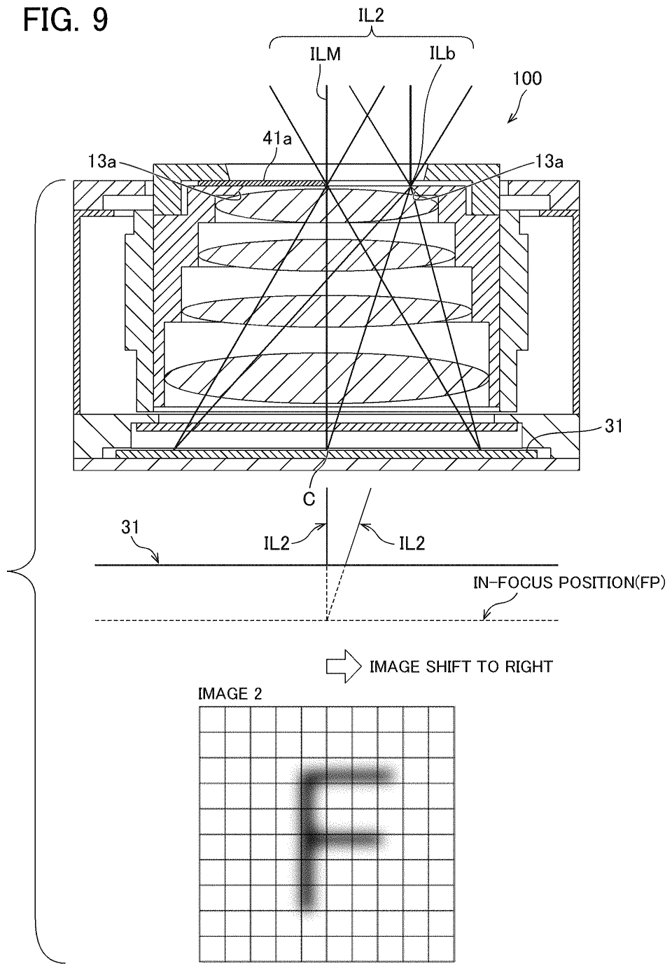

The shield device 40 changes into each of the first shield state and second shield state. However, the shield device 40 may be any device that changes into each of at least two shield states. The shield device 40 in the first shield state allows only a first light beam bundle IL1 (see FIG. 8), which is asymmetric with respect to a main light beam ILM of the entire light beam bundle IL (see FIG. 4) that passes through the entire opening 13a, to pass. The shield device 40 in the second shield state allows only a second light beam bundle IL2 (see FIG. 9), which is different from the first light beam bundle and is asymmetric with respect to the main light beam, to pass. This can offer a structure that achieves an image-plane phase-difference autofocus function, without providing a phase difference sensor in the image sensor 31.

Further, the shield device 40 in the first shield state covers a part of the opening 13a in such a manner that the first light beam bundle passes through one point ILa (see FIG. 8) located at the perimeter of an exit pupil. The shield device 40 in the second shield state in contrast covers another part of the opening 13a in such a manner that the second light beam bundle passes, in the plane of the exit pupil, through another point ILb (see FIG. 9) facing. It is noted that the foregoing one point ILa and other point ILb are two points (see FIG. 4) at which an imaginary straight line passing through the center point of a circular exit pupil intersects with the perimeter of the circular exit pupil in the front view (not shown) of the camera module 100. Accordingly, the image-plane phase-difference autofocus can be achieved with higher accuracy.

The shield device 40 is provided in a position adjacent to the aperture diaphragm 13 so as to be able to stop up the opening 13a. That is, the shield device 40 and the aperture diaphragm 13 are in contact. This enables the image-plane phase-difference autofocus to be executed with higher accuracy.

The control unit 50 determines the phase difference between a first image (image 1 in FIG. 8) of the first light beam bundle obtained by the image sensor 31 in the first shield state and a second image (image 2 in FIG. 9) of the second light beam bundle obtained by the image sensor 31 in the second shield state. The control unit 50 also controls the lens driving device 20 to move at least one lens 11 in accordance with the foregoing phase difference in such a manner that the lens system 10 is in focus. This can offer a control that achieves the image-plane phase-difference autofocus function, without using the image sensor 31 having a phase difference sensor.

The control unit 50 controls the lens driving device 20. The lens driving device 20 operates accordingly. As a result, at least one lens constituting the lens system 10 moves. This adjusts the lens system 10 into focus. The control unit 50 also executes a first control for bringing the shield device 40 into the first shield state, and a second control for bringing the shield device 40 into the second shield state.

The control unit 50 according to this preferred embodiment can automatically change the shield device 40 into each of the first shield state and second shield state for adjusting the lens system 10 into focus. The control unit 50 can also control the shield device 40 to bring both of the first shutter 41a and second shutter 41b into a closed state. The control unit 50 can also control the shield device 40 to bring both of the first shutter 41a and second shutter 41b into an open state.

The image-plane phase-difference autofocus function that is achieved by the camera module 100 according to this preferred embodiment will be described with reference to FIGS. 4 to 11. It is noted that for easy description, a subject to be taken is located at an infinite distance.

FIG. 4 illustrates the focus status of the camera module 100 according to this preferred embodiment.

As illustrated in FIG. 4, the thickness of a light beam bundle emitted from the subject located at a certain point, to be specific, the diameter of a circular section perpendicular to a main light beam of the light beam bundle is determined by the opening 13a of the aperture diaphragm 13. The light beam bundle is refracted by the lens system 10.

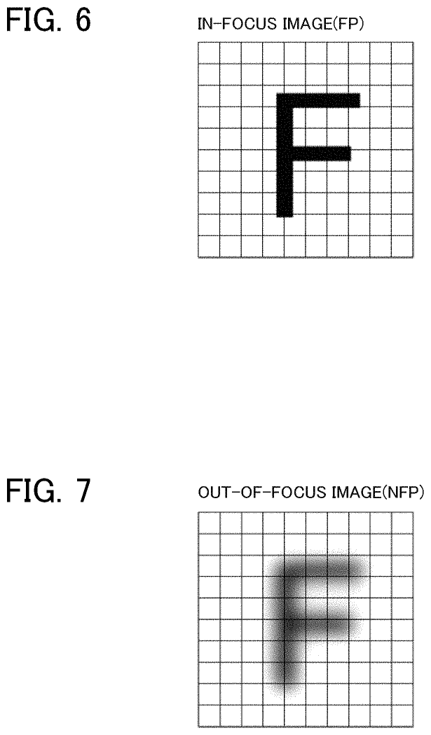

FIG. 5 illustrates the in-focus position and out-of-focus position of the camera module 100 according to this preferred embodiment. FIG. 6 illustrates an example image taken by the image sensor 31 with the camera module 100 according to the first preferred embodiment being in focus. FIG. 7 illustrates an example image taken by the image sensor 31 with the camera module 100 according to the first preferred embodiment being out of focus.

When the lens system 10 illustrated in FIG. 5 is located in a position where its focus is achieved, a light beam bundle (incident light IL) concentrates substantially onto one point C on the image sensor 31. The image sensor 31 thus obtains such an image where the lens system 10 is in focus as illustrated in FIG. 6, that is, an image FP.

When the lens system 10 illustrated in FIG. 5 is located in a position where its focus is not achieved, that is, at a position where the lens system 10 is out of focus, a light beam bundle (incident light IL) concentrates onto the image sensor 31 widely. The image sensor 31 thus obtains such a blurring image as illustrated in FIG. 7, that is, an out-of-focus image, in other words, an out-of-focus image NFP. It is noted that the out-of-focus image NFP blurs to the same degree also in an instance where the lens system 10 is located in either of a position closer to the subject than its in-focus position and a position opposite to the subject.

It is noted that the subject in this preferred embodiment is assumed to be located at an infinite distance along the optical axis of the camera module 100. However, it is uncertain where the subject is located actually. It is thus difficult to determine which of the positions each lens 11 constituting the lens system 10 that is optimal for in-focus is located in. That is, it is normally difficult to determine instantly whether the lens system 10 is in focus by moving each lens 11 constituting the lens system 10 to either of the positions even when the fact that the lens system 10 is out of focus is recognized.

FIG. 8 illustrates the relationship between the first shield state of the shield device 40 of the camera module 100 according to this preferred embodiment, light IL incident upon the image sensor 31, and an image (see image 1 in FIG. 8) obtained by the image sensor 31. FIG. 9 illustrates the relationship between the second shield state of the shield device 40 of the camera module 100 according to this preferred embodiment, light IL incident upon the image sensor 31, and an image (see image 2 in FIG. 9) obtained by the image sensor 31.

As illustrated in FIGS. 8 and 9, there is occasionally a focus position behind the image sensor 31, that is, opposite where the lens system 10 of the image sensor 31 is provided. In this case, a half light beam bundle that passes through one of the sides (e.g., left side) of an exit pupil enters the image sensor 31 while biased to one of the sides, that is, the left side, whereas a half light beam bundle that passes through the other side (i.e., right side) of the exit pupil enters the image sensor 31 while biased to the other side, that is, the right side.

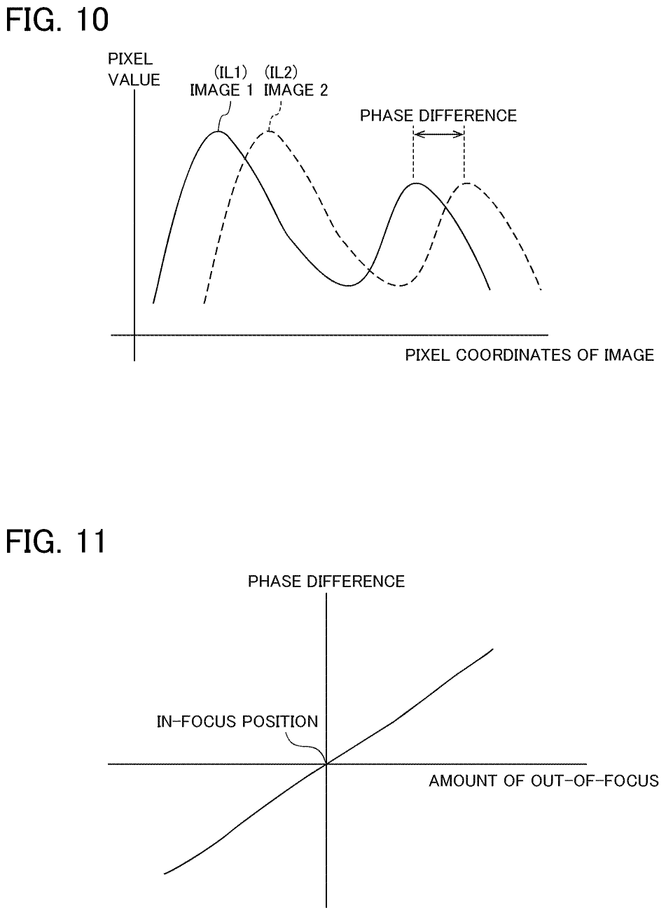

FIG. 10 illustrates disagreement between the coordinates of an image (see image 1 in FIG. 8) obtained by the image sensor 31 in the first shield state in this preferred embodiment and the coordinates of an image (see image 2 in FIG. 9) obtained by the image sensor 31 in the second shield state. FIG. 11 illustrates the relationship between phase difference and out-of-focus in the image-plane phase-difference autofocus of the camera module 100 according to this preferred embodiment.

That is, divided images that are formed by a light beam bundle undergone pupil division are formed while biased to one side or the other side, for instance, the right side or the left side, in accordance with the focus status of the lens system 10, as illustrated in FIGS. 10 and 11. The amount of a right-and-left positional shift between the divided images is commonly referred also to as a phase difference. A phase difference herein is the difference in phase between the output waveforms of such divided images as illustrated in FIG. 10 with respect to light reflected on a subject. That is, the positional shift between the divided images per se is a phase difference. Further, it is known that the amount of shift between a phase difference and a focus has a relation that is approximate to a highly correlating linear function with its origin point at zero.

When the phase difference stands at zero, the amount of out-of-focus also stands at zero and can be hence derived from these phase difference and correlation expression. Deriving the amount of out-of-focus on the basis of the phase difference is the fundamental principle of the image-plane phase-difference autofocus.

In contrast, the camera module 100 according to this preferred embodiment determines the phase difference between a plurality of images formed by a light beam bundle undergone pupil division similarly and derives the amount of out-of-focus on the basis of the determined phase difference. The following describes how to determine the phase difference.

The shield device 40 blocks a light beam bundle that travels toward the image sensor 31 in at least two kinds of state. For instance, the shield device 40 in the first shield state blocks the light beam bundle in such a manner that the light beam bundle is asymmetric with respect to a main light beam, and that the light beam bundle passes through any one end of an exit pupil. The shield device 40 in the second shield state for instance blocks the light beam bundle in such a manner that the light beam bundle is asymmetric with respect to the main light beam, and that the light beam bundle passes through any another end of the exit pupil different from the one end in the first shield state.

The foregoing configuration enables pupil division only in the shield device 40. This eliminates the need for an image sensor that includes a phase difference sensor. As a result, the camera module 100 can achieve the image-plane phase-difference autofocus function without depending on an image sensor.

Further, the camera module 100 according to this preferred embodiment performs pupil division on light beams in the position of the aperture diaphragm 13. Thus, the entire light beam bundle in the lens system 10 undergo pupil division irrespective of the position (image height) of the image sensor 31. Thus, a focus position can be detected in any position of an image. This improves the accuracy of the image-plane phase-difference autofocus. In addition, the phase difference of light incident from any location selected by a user of the camera module 100 can be obtained from a preview image taken by the camera, and the focus of the lens system 10 can be adjusted to this location.

The following describes a method for achieving autofocus using the camera module 100 according to this preferred embodiment.

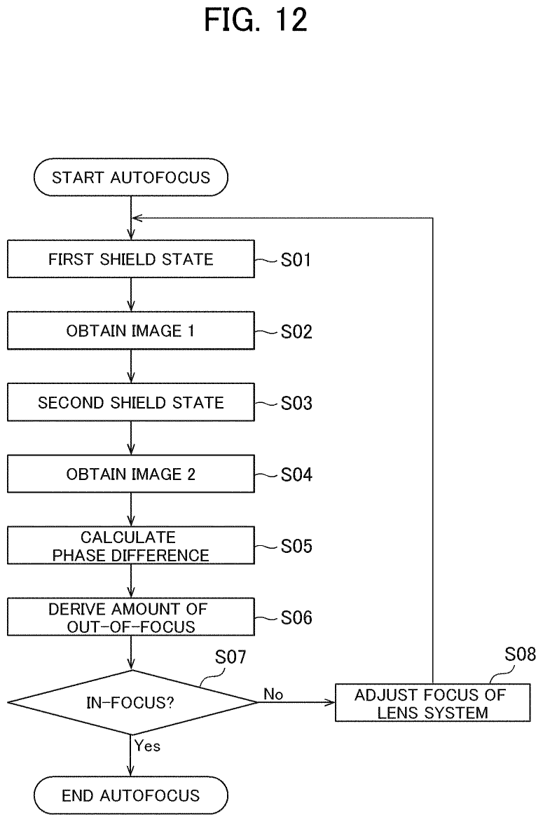

FIG. 12 is a flowchart showing an autofocus procedure in the camera module 100 according to this preferred embodiment.

As illustrated in FIG. 12, the control unit 50 firstly operates the opening-and-closing mechanism 42 of the shield device 40 in Step S01. Accordingly, each of the first shutter 41a and second shutter 41b operates independently, and incident light IL is blocked selectively.

In more detail, the control unit 50 brings the shield device 40 into the first shield state in Step S01. Accordingly, the shield device 40 blocks a light beam bundle in such a manner that the light beam bundle is asymmetric with respect to its main light beam, and that the light beam bundle passes through any one end of an exit pupil. That is, in this preferred embodiment, the control unit 50 in the first shield state controls the shield device 40 not to cover the opening 13a with the first shutter 41a, but to cover the opening 13a with the second shutter 41b (see FIG. 8).

Next in Step S02, the control unit 50 brings the shield device 40 into the first shield state. Accordingly, the control unit 50 controls the image sensor 31 to take an image 1 (see image 1 in FIG. 8) of a first light beam bundle in the first shield state.

Thereafter in Step S03, the control unit 50 brings the shield device 40 into the second shield state. Accordingly, in this preferred embodiment, the shield device 40 blocks the light beam bundle in Step S03 in such a manner that the light beam bundle is asymmetric with respect to its main light beam, and that the light beam bundle passes through any another end of the exit pupil different from that in Step S01. That is, the control unit 50 controls the shield device 40 to cover the opening 13a with the first shutter 41a, but not to cover the opening 13a with the second shutter 41b (see FIG. 9).

Next in Step S04, the control unit 50 brings the shield device 40 into the second shield state. Accordingly, the control unit 50 controls the image sensor 31 to take an image 2 (see image 2 in FIG. 9) of a second light beam bundle in the second shield state.

Thereafter in Step S05, the control unit 50 calculates the phase difference (see FIG. 10) between the image 1 and the image 2 as the amount of positional shift between the image 1 and the image 2. The phase difference between the image 1 and the image 2 may be determined by a data table stored in the control unit 50.

Next in Step S06, the control unit 50 uses the determined phase difference to thus derive the amount of out-of-focus on the basis of the known correlation between a phase difference and the amount of out-of-focus illustrated in FIG. 11. The control unit 50 may calculate the amount of out-of-focus by using, for instance, the determined phase difference and an arithmetic expression indicating the foregoing correlation between the phase difference and the amount of out-of-focus. The control unit 50, which stores the correlation between the phase difference and the amount of out-of-focus in the form of a data table, may also derive the amount of out-of-focus (defocus amount) by using the determined phase difference and the data table.

It is noted that the method of determining the phase difference in Step S05 and the method of deriving the amount of out-of-focus in Step S06 are each in detail performed in the same process as, for instance, the known image-plane phase-difference autofocus earlier described in Patent Literature 1 and other documents. The detailed description of them will be hence omitted in the Specification.

Thereafter in Step S07, the control unit 50 determines whether the lens system 10 is in focus on the basis of the foregoing amount of out-of-focus. Upon determining in Step S07 that the lens system 10 is not in focus, the control unit 50 adjusts, in Step S08, the focus of the lens system 10 and then executes Step S01 again, i.e., derivation of the amount of out-of-focus. In contrast, upon determining that the lens system 10 is in focus, the control unit 50 ends the autofocus process.

As described above, the camera module 100 according to this preferred embodiment needs no phase difference sensor. This can achieve the image-plane phase-difference autofocus function without depending on the image sensor 31.

### Second Preferred Embodiment

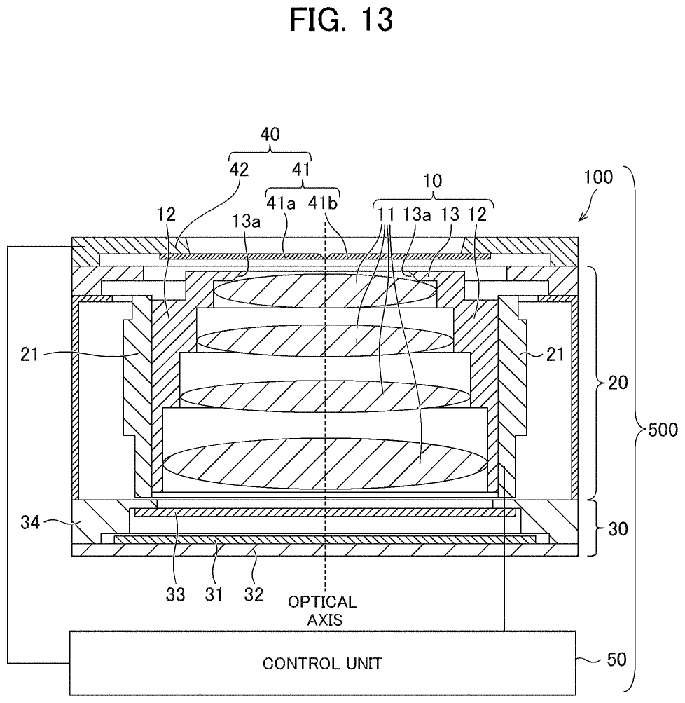

The following describes the camera module 100 according to a second preferred embodiment and the mobile terminal 500 incorporating the same with reference to FIG. 13. It is noted that the description that the camera module 100 and the mobile terminal 500 incorporating the same are similar to those in the first embodiment will not be repeated in the following. The camera module 100 according to this preferred embodiment and the mobile terminal 500 incorporating the same is different from the camera module 100 according to the first preferred embodiment and the mobile terminal 500 incorporating the same in the following regards.

FIG. 13 is a sectional view of a schematic configuration of the camera module 100 according to this preferred embodiment.

As illustrated in FIG. 13, the shield device 40 is provided in a position spaced from a position adjacent to the aperture diaphragm 13 toward a subject. That is, there is a space between the shield device 40 and the aperture diaphragm 13. This improves flexibility in designing the camera module 100. It is noted that the amount of out-of-focus in this case is derived from an image near the optical axis of the lens system 10.

The camera module 100 according to this preferred embodiment performs pupil division on light beams by using only an image near the optical axis. It is hence difficult to improve focus accuracy and to achieve focus at any location. However, the shield device 40 of the camera module 100 according to this preferred embodiment can be provided outside the camera module 100. This offers an advantage, i.e., enhanced flexibility in the placement of the shield device 40.

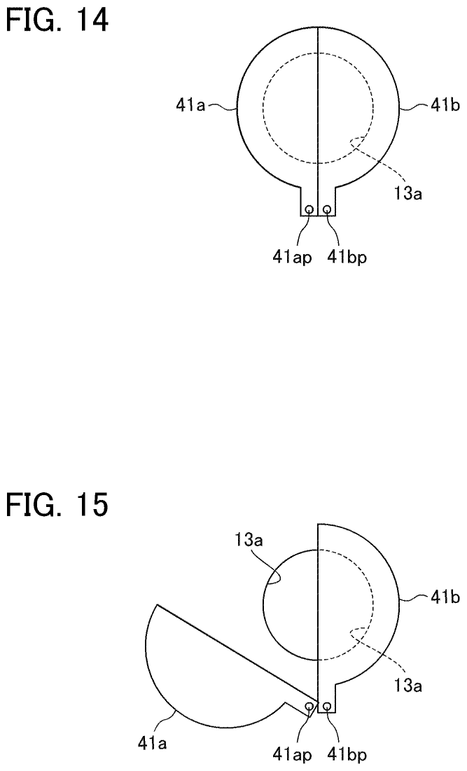

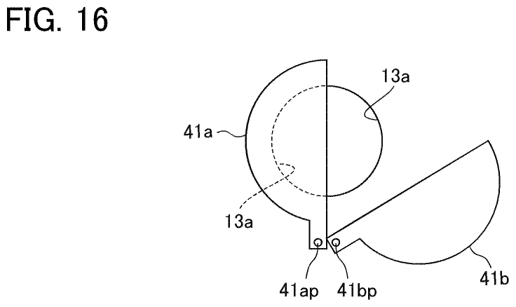

FIG. 14 illustrates the shield device 40 of the camera module 100 according to this preferred embodiment covering the opening 13a. FIG. 15 illustrates the shield device 40 of the camera module 100 according to this preferred embodiment being in a first shield state. FIG. 16 illustrates the shield device 40 of the camera module 100 according to this preferred embodiment being in a second shield state.

In the front view (not shown) of the camera module 100, the shield device 40 in a complete shield state covers the entire opening 13a with the first shutter 41a and second shutter 41b, as illustrated in FIG. 14. The opening 13a is circular. Each of the first shutter 41a and second shutter 41b has a semicircular portion. The first shutter 41a and the second shutter 41b in their closed state form a concentric circuit having a center common with that of the circle of the opening 13a.

As seen from FIG. 15, the first shutter 41a in the first shield state rotates around a first hinge 41ap in the front view (not shown) of the camera module 100 to thus expose a part of the opening 13a. In contrast, the second shutter 41b covers another part of the opening 13a in the front view (not shown) of the camera module 100.

As seen from FIG. 16, the first shutter 41a in the second shield state covers a part of the opening 13a in the front view (not shown) of the camera module 100. In contrast, the second shutter 41b in the second shield state rotates around a second hinge 41bp in the front view (not shown) of the camera module 100 to thus expose another part of the opening 13a.

The shield device 40 according to this preferred embodiment can establish the first shield state and the second shield state easily by using the foregoing first shutter 41a and second shutter 41b.

### Third Preferred Embodiment

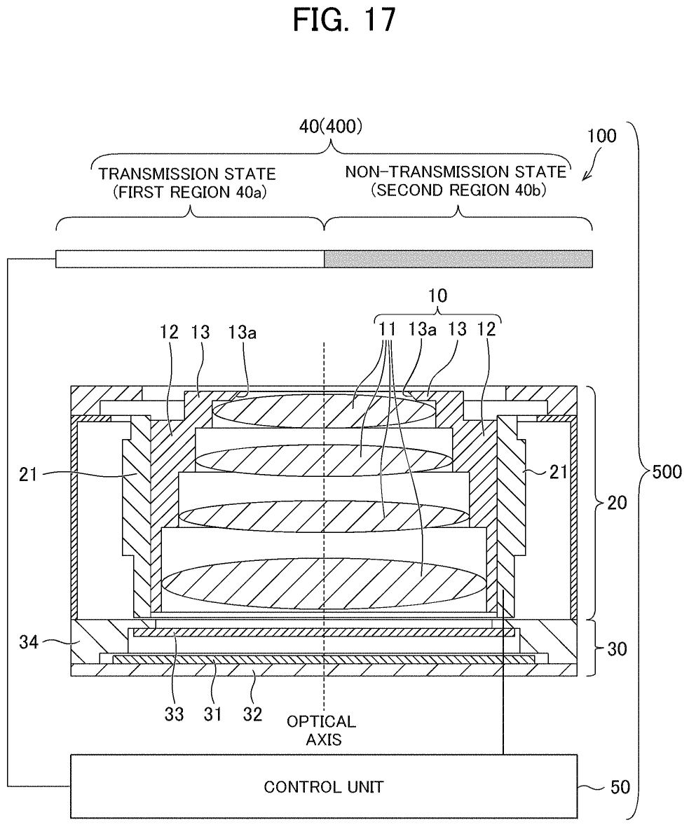

The following describes the camera module 100 according to a third preferred embodiment and the mobile terminal 500 incorporating the same with reference to FIGS. 17 to 19. It is noted that the description that the camera module 100 and the mobile terminal 500 incorporating the same are similar to those in the first embodiments will not be repeated in the following. The camera module 100 according to this preferred embodiment and the mobile terminal 500 incorporating the same is different from the camera module 100 according to the first preferred embodiment and the mobile terminal 500 incorporating the same in the following regards.

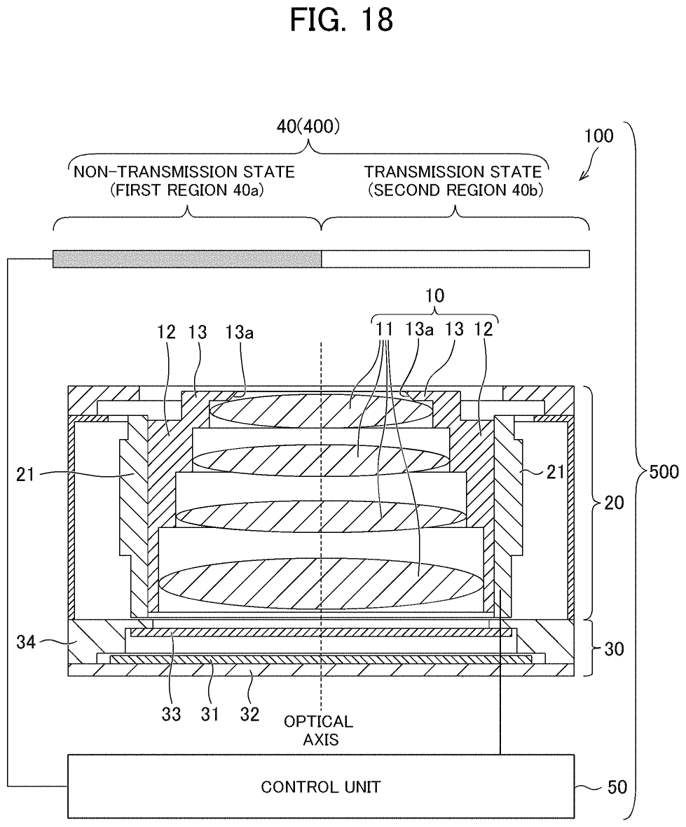

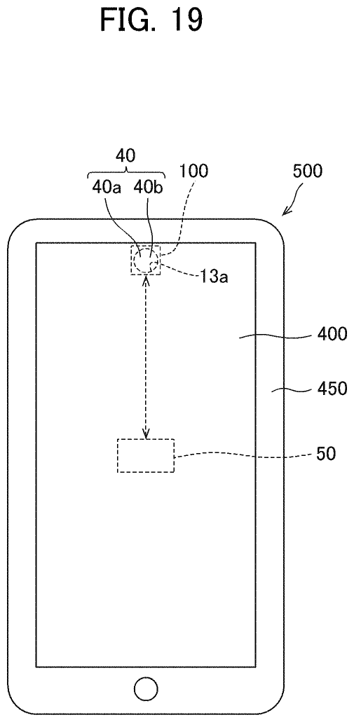

FIG. 17 is a sectional view of the shield device 40 of the camera module 100 according to this preferred embodiment being in a first shield state. FIG. 18 is a sectional view of the shield device 40 of the camera module 100 according to this preferred embodiment being in a second shield state. FIG. 19 illustrates the mobile terminal 500 incorporating the camera module 100 according to this preferred embodiment.

As illustrated in FIGS. 17 and 18, the shield device 40 is a transmission/non-transmission switching panel unit (a part of the display panel 400). The transmission/non-transmission switching panel unit (a part of the display panel 400) includes a first region 40a and a second region 40b. The control unit 50 controls each of the first region 40a and second region 40b independently into one of a transmission state and a non-transmission state by controlling the transmission/non-transmission switching panel unit.

The first region 40a is brought into the transmission state in the foregoing first shield state and is brought into the non-transmission state in the foregoing second shield state. The second region 40b is brought into the non-transmission state in the foregoing second shield state and is brought into the transmission state in the foregoing second shield state. As such, the shield device 40 can be formed using the transmission/non-transmission switching panel unit.

The transmission/non-transmission switching panel unit is a part of the display panel 400 that displays an image taken in the mobile terminal 500. Thus, the shield device 40 can be formed using the display panel 400 of the mobile terminal 500.

To be specific, as illustrated in FIG. 19, the shield device 40 of the camera module 100 is achieved by a part of the display panel 400, such as the liquid crystal panel or organic electroluminescence (EL) panel of a mobile terminal called a smartphone.

In this preferred embodiment, the control unit 50 selectively switches some of the regions of the display panel 400, i.e., each of the foregoing first region 40a and second region 40b, into one of a transmission region and a non-transmission region. This can achieve the shield device 40 using the transmission/non-transmission switching panel unit.

Typically, for mounting a front camera onto a smartphone, a space is needed for providing the front camera. This space is commonly the smartphone's bezel, a space inside the bezel inside the notch of the display panel, or a space inside the pin hole or other things of the display panel. Providing the front camera in any of these spaces unfortunately reduces the effective screen size of the display panel 400.

However, a technique called under-display cameras for solving the above problem has been known in recent years. The front camera of such an under-display camera is mounted inside its display panel. In this case, the camera, when used, can take a light beam bundle into a region of the image sensor by letting light beams pass through the display panel. In contrast, the camera, when not used, can be used as a non-transmissive display panel. As such, the smartphone's display panel can be utilized as much as possible.

The camera module 100 according to this preferred embodiment is applied to the front camera of the foregoing under-display. The shield device 40 can be thus achieved without an additional shield device by switching some of the regions of the display panel 400 into one of transmission and non-transmission regions. Further, the shield device 40, which can switch between transmission and non-transmission instantaneously, enables speedy autofocus.

The use of the foregoing camera module 100 according to each of the first to third preferred embodiments is not limited to a smartphone. The camera module 100 is also applicable to, for instance, a machine vision camera that is used for, but not limited to, inspection of components, half-completed products or products in a factory production line.

To commonly perform size inspection on the depth of a product in a factory production line, a distance measuring means having a light source, such as an infrared light, is used other than a camera, distance measurement is performed with two or more cameras, or a special camera incorporating two or more sensors is used.

Applying the foregoing camera module 100 according to this preferred embodiment to a machine vision camera enables the focus position within an image to be detected instantaneously. Consequently, a size abnormality in the depth of a product can be detected by such a simple configuration as a single camera, i.e., a single sensor. In addition, a cost for introducing a machine vision camera and a space for placing the same can be saved.

The foregoing camera modules 100 according to the respective preferred embodiments are applicable particularly to various electronic apparatuses, including communication apparatuses (e.g., smartphones), digital cameras, mobile communication terminals, and laptop or tablet personal computers. The foregoing camera modules 100 according to the respective preferred embodiments are also applicable to camera modules that are mounted on drones and on autonomous or driving-assist transportation means and are also applicable to machine vision cameras in factory production lines.

While there have been described what are at present considered to be certain embodiments of the invention, it will be understood that various modifications may be made thereto, and it is intended that the appended claim cover all such modifications as fall within the true spirit and scope of the invention.

What is claimed is:

1. A camera module comprising:
an image sensor configured to perform photoelectric conversion on incident light;
a lens system configured to concentrate the incident light that travels toward the image sensor;
an aperture diaphragm having an opening that allows the incident light that travels toward the lens system to pass; and
a shield device capable of shielding at least a part of the opening,
wherein the shield device changes into at least each of
a first shield state where only a first light beam bundle asymmetric with respect to a main light beam of an entire light beam bundle that passes through the entire opening is allowed to pass, and
a second shield state where only a second light beam bundle different from the first light beam bundle and asymmetric with respect to the main light beam is allowed to pass.

2. The camera module according to claim 1, wherein
the shield device
in the first shield state, shields a part of the opening in such a manner that the first light beam bundle passes through one point at a perimeter of an exit pupil, and
in the second shield state, shields another part of the opening in such a manner that the second light beam bundle passes, in a plane of the exit pupil, through another point facing the one point.

3. The camera module according to claim 1, comprising:
a lens driving device configured to move at least one lens constituting the lens system; and
a control unit configured to control the lens driving device,
wherein the control unit
determines a phase difference between a first image of the first light beam bundle obtained by the image sensor in the first shield state and a second image of the second light beam bundle obtained by the image sensor in the second shield state, and
controls the lens driving device to move the at least one lens in accordance with the phase difference in such a manner that the lens system is in focus.

4. The camera module according to claim 3, wherein the control unit executes a first control for bringing the shield device into the first shield state, and a second control for bringing the shield device into the second shield state.

5. The camera module according to claim 1, wherein the shield device is provided in a position adjacent to the aperture diaphragm so as to be able to stop up the opening.

6. The camera module according to claim 1, wherein the shield device is provided in a position spaced from a position adjacent to the aperture diaphragm toward a subject.

7. The camera module according to claim 1, wherein
the shield device includes
a first shutter that is opened in the first shield state and is closed in the second shield state, and
a second shutter that is closed in the first shield state and is opened in the second shield state.

8. A mobile terminal comprising the camera module according to claim 1,
wherein the shield device includes a transmission/non-transmission switching panel unit,
the transmission/non-transmission switching panel unit includes
a first region that is brought into a transmission state in the first shield state, and that is brought into a non-transmission state in the second shield state, and
a second region that is brought into a non-transmission state in the first shield state, and that is brought into a transmission state in the second shield state, and
the transmission/non-transmission switching panel unit is a part of a display panel configured to display an image.
